(19) United States
(12) Patent Application Publication
(10) Pub. No.: US 2008/0164646 A1
(43) Pub. Date: Jul. 10, 2008

(54) WORKHOLDER FOR SUPPORTING ELECTRONIC DEVICES

(76) Inventors: Chi Wah Cheng, Hong Kong (CN); Wang Lung Alan Tse, Hong Kong (CN)

Correspondence Address: OSTROLENK FABER GERB & SOFFEN, 1180 AVENUE OF THE AMERICAS, NEW YORK, NY, 100368403, US

(21) Appl. No.: 11/621,531

(22) Filed: Jan. 9, 2007

(51) Int. Cl. B23Q 3/02

(52) U.S. Cl. 269/16

(57) ABSTRACT

A workholder, in particular a saw jig, is provided for mounting a substrate containing a plurality of electronic devices. The saw jig has a base platform having a plurality of pockets laid out in the same arrangement as the electronic devices are arranged on the substrate and a plurality of resilient collets are detachably inserted into the pockets, each collet being sized and configured to hold one electronic device by vacuum suction.

### FIELD OF THE INVENTION

The invention relates to support structures or workholders such as saw jigs for holding electronic devices securely when processing the electronic devices, and in particular, to resilient holders located on the support structures for mounting said electronic devices.

### BACKGROUND AND PRIOR ART

Conventionally, a number of electronic devices such as electronic packages are manufactured on a single strip of molded substrate comprising a plurality of such packages during semiconductor assembly and packaging, and it is necessary to separate them into singulated packages before offloading them. When singulating the electronic packages, for example, by using a dicing saw, it is usual to use a support structure such as an adhesive surface or vacuum chuck to hold the molded packages in place during the cutting process.

Thus, one way of holding the substrate is by the use of a wafer frame and UV adhesive tape to secure the packages in place during the singulation, which binds all the individual packages to the adhesive surface during the cutting process. However, as the dicing blade will come into contact with the adhesive tape during cutting, some adhesive will bond to the blade and reduce its effectiveness. Another disadvantage of this process is that there may be adhesive still remaining on the package even after it is removed from the tape. It may become a source of contaminant for the rest of the manufacturing processes.

Another way is to use a chuck with a suction device, similar to that described in U.S. Pat. No. 5,803,797 for a “Method and Apparatus to Hold Integrated Circuit Chips onto a Chuck and to Simultaneously Remove Multiple Integrated Circuit Chips from a Cutting Chuck”. In a fixture-based singulation process employing a saw, chip-array electronic packages of a substrate are cut to their individual dimensions and separated from one another on a vacuum chuck with an elastomeric surface. The edge scrap of the substrate will be washed away from the cutting chuck by coolant and cleaning water generated in association with the dicing saw. The sawn packages will be held onto the chuck until the cutting process is completed and the packages are ready to be unloaded to the next handling process.

With the aforesaid approach, the vacuum chuck is required in order to hold the substrate and the partially sawn packages firmly during sawing. It is usually machined from one piece of rubber for the whole substrate or one piece of rubber per mold panel. It is difficult to fabricate as a lot of small pockets and small holes are made on the rubber sheet that is adhered onto a metal plate. Since there is usually one pocket or hole per one package, that means that if there are a total of 500 packages per substrate, 500 corresponding small pockets and holes are required to hold all the packages. Hence, the manufacturing time and cost are high.

Moreover, it is unproductive when the whole jig or whole panel has to be re-done if just one pocket or hole is incorrectly made. Although the rubber panel can be made by molding, some shrinkage of the molded part typically occurs during setting. It is not easy to properly control such molding shrinkage problem. Moreover, the cost of molding is comparatively high as one molded pattern for one type of substrate is not usable for other substrates with differently-positioned arrays. The rubber commonly also has aging problems after it has been used for months and thus the positions of the pockets and holes may become misaligned.

A different approach is disclosed in U.S. Pat. No. 5,671,910 entitled “Vacuum Plates”. A vacuum plate system comprises a support plate formed of a plurality of support plate modules that are supported on a base plate and serve to transfer vacuum between vacuum apertures in the base plate and a workpiece held on the support plate. The support plate module is formed with a plurality of circular lip seals of larger size, and disposed therebetween, a plurality of lip seals of smaller size. In the machining of a workpiece held on the support plate modules, the lip seals may be cut into, without risk of losing the overall vacuum holding effect on the workpiece.

However, the lip seals are not constructed according to the sizes of the packages so that it is more difficult to hold the packages securely after they are separated, and if the lip seals are cut into, they will have to be replaced, resulting in increased time and costs of replacement lip seals after each machining operation. Furthermore, the lip seals are preferably formed integrally with an elastic mat, making it difficult to replace individual seals. Although the disclosure briefly describes having discrete discs, these have to be glued onto a vacuum module with adhesive and have the problem that adhesive deteriorates over time. To avoid reliability issues, the adhesive would have to be strong so that they do not come off when a workpiece is being machined. That may be why the disclosure states that it is preferred that the discs are formed integrally with the main body of the vacuum module. If there are many small discs to be installed, it would also be time consuming to individually position and glue each disc, rather than just inserting them, which makes the approach less attractive.

### SUMMARY OF THE INVENTION

It is thus an object of the invention to seek to provide a workholder with a resilient holding surface for supporting electronic devices during singulation thereof that is easier to manufacture and more durable than some of the above prior art. It is a related object of the invention to seek to provide a holder for a workholder surface which is more versatile in use such that it can be used for multiple support purposes.

Accordingly, the invention provides a saw jig for mounting a substrate containing a plurality of electronic devices, comprising a base platform having a plurality of pockets laid out in the same arrangement as the electronic devices are arranged on the substrate, and a plurality of resilient collets that are detachably inserted into the pockets, each collet being sized and configured to hold one electronic device by vacuum suction.

It would be convenient hereinafter to describe the invention in greater detail by reference to the accompanying drawings which illustrates a preferred embodiment of the invention. The particularity of the drawings and the related description is not to be understood as superseding the generality of the broad identification of the invention as defined by the claims.

### BRIEF DESCRIPTION OF THE DRAWINGS

Example of preferred embodiments of workholders in accordance with the invention will now be described with reference to the accompanying drawings, in which:

FIG. 1 is an isometric view of a saw jig with individual round collets according to the first preferred embodiment of the invention;

FIG. 2 is an isometric view of the saw jig of FIG. 1 with the individual round collets removed to show the pockets drilled into the saw jig base to support the round collets;

FIG. 3 is a cross-sectional view of a round collet that is inserted into a pocket of the saw jig base;

FIG. 4 is a cross-sectional view of an individual round collet;

FIG. 5 is an isometric view of the round collet of FIG. 4;

FIG. 6 is an isometric view of a vacuum pick head with individual round collets as shown in FIG. 5 that are arranged in a row on the pick head;

FIG. 7 is a cross-sectional view of a round collet inserted into a pocket of the vacuum pick head;

FIG. 8 is an isometric view of a saw jig with individual rectangular collets according to the second preferred embodiment of the invention;

FIG. 9 is an isometric view of the saw jig of FIG. 8 with the individual rectangular collets removed to show the pockets drilled into the saw jig base to support the rectangular collets;

FIG. 10 is a cross-sectional view of a rectangular collet that is inserted into a pocket of the saw jig base;

FIG. 11 is a cross-sectional view of an individual rectangular collet;

FIG. 12 is an isometric view of the rectangular collet of FIG. 11;

FIG. 13 is an isometric view of a vacuum pick head with individual rectangular collets as shown in FIG. 12 that are arranged in a row on the pick head;

FIG. 14 is a cross-sectional view of a rectangular collet that is inserted into a pocket of the vacuum pick head;

FIG. 15 is an isometric view of a saw jig having a thin rubber sheet over its surface and individual rectangular collets according to the third preferred embodiment of the invention;

FIG. 16 is an isometric view of the saw jig base having the thin rubber sheet over its surface with the individual rectangular collets removed to show the pockets drilled into the rubber sheet and saw jig base to support the rectangular collets;

FIG. 17 is a cross-sectional view of a rectangular collet that is inserted into a pocket of the saw jig base according to the third preferred embodiment of the invention;

FIG. 18 is a cross-sectional view of an individual rectangular collet according to the third preferred embodiment;

FIG. 19 is an isometric view of the rectangular collet of FIG. 18.

### DETAILED DESCRIPTION OF THE PREFERRED EMBODIMENT OF THE INVENTION

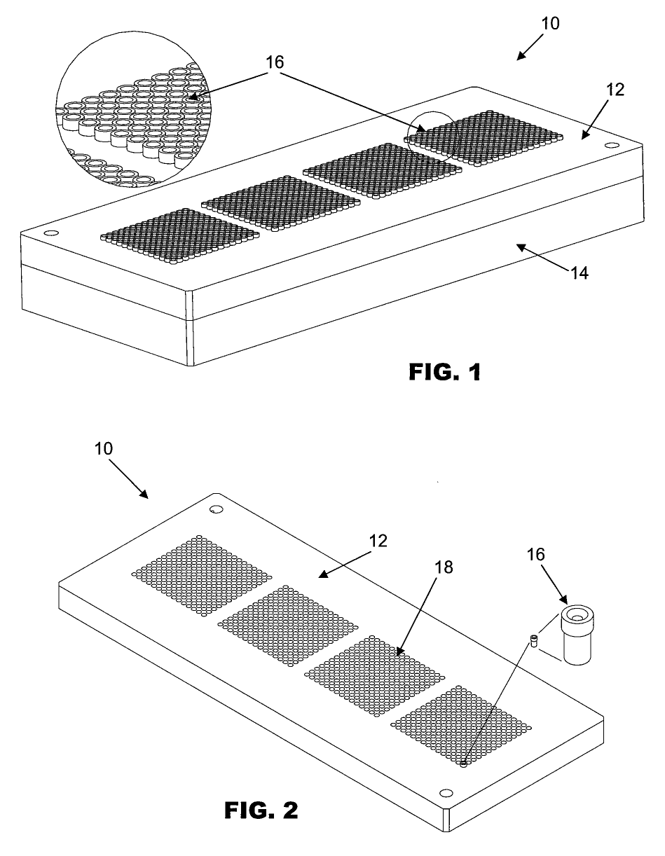

FIG. 1 is an isometric view of a saw jig 10 with individual round collets 16 according to the first preferred embodiment of the invention. The saw jig 10 is used for mounting a substrate (not shown) containing a plurality of electronic devices such as electronic packages, and comprises a base platform in the form of a saw jig base 12 and a base holder 14. A plurality of individual round collets 16 are arranged in an array pattern over the surface of the saw jig base 12 in the same positions as the arrangement of the individual electronic packages on the substrate to be cut. The saw jig 10 is connected to a vacuum source, such that vacuum suction can be generated at the holding surfaces at the top of the round collets 16. After the substrate is cut and the electronic packages are separated, each round collet 16 should preferably be of the appropriate size to be configured to hold one electronic package securely by vacuum suction.

The saw jig base 12 is preferably made from metal, such as aluminum, for the sake of easy machining and durability. Comparatively, machining on aluminum is easier than on elastomeric material such as rubber, since rubber is usually too soft to be machined accurately and efficiently.

For smaller packages (e.g., for packages of between 3×3 mm and 9×9 mm), round-shaped vacuum collets are preferably used. This is because for small units, the pockets on the saw jig base 12 are small and it is difficult to make rectangular pockets or pockets for guiding the orientation of the collets during insertion. The round collets 16 can already cover sufficient areas of the electronic packages to generate enough suction force for holding the electronic packages firmly during sawing.

FIG. 2 is an isometric view of the saw jig 10 of FIG. 1 with the individual round collets 16 removed to show the pockets 18 drilled into the saw jig base 12 to support the round collets 16. The plurality of pockets 18 are laid out in the same arrangement as the electronic packages are arranged on a substrate to be cut. Each individual round collet 16 is detachably inserted into one pocket formed in the saw jig base 12, until all the pockets 18 of the saw jig base 12 are filled with the round collets 16.

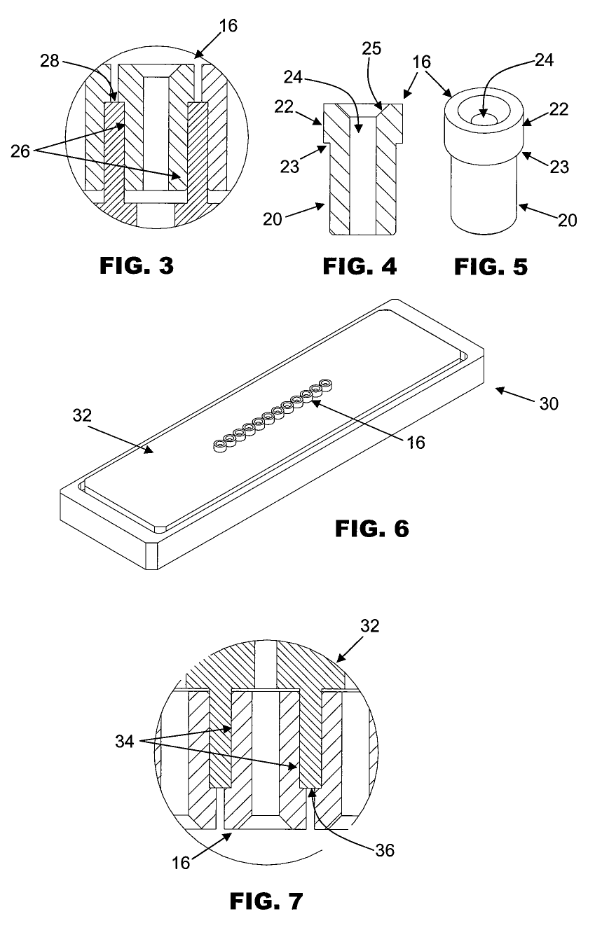

FIG. 3 is a cross-sectional view of a round collet 16 that is inserted into a pocket 18 of the saw jig base 12. Each pocket 18 has guide walls 26 conforming to the shape of the round collet 16 to facilitate insertion of the round collet 16 into the pocket 18. Each pocket 18 further has a reference surface 28 associated with it to act as a stopper during insertion of the round collet 16. The reference surfaces 28 are planar and are all located at the same height on the saw jig base 12 to ensure that the heights of all the collets are substantially the same. In this case, the reference surfaces 28 are located on the flat top surface of the saw jig base 12.

The pockets on the saw jig base 12 may consist of several key parts. The pocket 18 has a blind hole which is of the same nominal diameter as that of the outer surface of the lower part of the round collet 16. However, the diameter tolerance of the blind pocket is between zero and negative or slightly positive, while that of the outer surface of the lower part of the round collet 16 is between zero to positive. As a result, each pocket 18 is constructed to form an interference fit with the round collet 16 and thus the collet 16 can be inserted into the pocket 18 conveniently and firmly with a slight insertion force. Thereafter, it is securely mounted. The use of adhesive, which may tend to deteriorate in the long run, can be avoided.

At the top of the pocket 18, the flat reference surface 28 extends across the top of the whole saw jig base 12. It is this surface that the shoulders of the round collets 16 rest on. As the shoulders of the round collets 16 are also reference surfaces, the heights of the collets protruding from the jig base are well controlled. This is important for holding a substrate evenly across a plurality of collets. The lower parts of the pockets 18 of the saw jig base 12 include through holes that are configured to transmit vacuum suction from a chuck table of a saw engine to the saw jig 10 and the round collets 16 to hold the packages using vacuum suction.

FIG. 4 is a cross-sectional view of an individual round collet 16. FIG. 5 is an isometric view of the round collet 16 of FIG. 4. The round collet 16 generally comprises a cylindrical stem 20, a cylindrical head 22 and a substantially flat shoulder 23 between the stem 20 and the head 22. The head 22 is configured to be exposed above the saw jig base 12 after insertion of the stem 20 into the pocket 18. Preferably, the stem 20 has a smaller diameter than the head 22. An inner vacuum hole 24 passes centrally through the round collet 16.

The shoulder 23, together with the top surface of the saw jig base 12, forms a planar reference surface which preferably acts as a stopper or reference to control the depth of insertion of the round collet 16. When the round collet 16 is inserted into a pocket 18 on the saw jig base 12, the shoulder 23 is made to rest on the reference surface 28 to maintain consistency in the heights of the round collets 16. The head 22 preferably includes a chamfer 25 at its suction surface adjoining the inner vacuum hole 24 where an electronic package is supported to provide a larger vacuum suction area so as to increase suction force holding the electronic package.

Collets are preferably made by molding with rubber or elastomer because the collet design can be standardized for a certain package size. They can be applied not only to saw jigs, but can also be used for other applications such as vacuum pick heads. The quantity of collets that are usable for package handling and processing will therefore be large enough to justify the initial mold tooling cost. As a result, the overall cost of manufacturing is low comparing with those made from machining. The molding material can be chosen according to different requirements such as hardness and electrical conductivity. Usually, softer rubber is preferred for better vacuum sealing. Anti-static is also preferred.

FIG. 6 is an isometric view of a vacuum pick head 30 with individual round collets 16 as shown in FIG. 5 that are arranged in a row on the pick head 30. It shows the versatility of the round collets 16 in that they can be used for multiple functions. Such a vacuum pick head 30 can be applied to transfer multiple electronic packages at once from one location to another. Alternatively, the pick head 30 may be configured to transfer one package at a time. As described in relation to the saw jig 10, the round collets 16 are arranged according to the positions of the electronic packages to be picked up, each round collet 16 being operative to hold one electronic package. The round collets 16 are inserted into pockets drilled into the holder 32 of the vacuum pick head 30.

FIG. 7 is a cross-sectional view of a round collet 16 inserted into a pocket of the vacuum pick head 30. The manner of insertion of the round collets 16 into the holder 32 is essentially identical to that described for the saw jig 10. Each round collet 16 is inserted into a pocket that has guide walls 34 corresponding to the shape of the stem 20 of the round collet 16. The round collet 16 is pushed in until its shoulder 23 contacts the reference surface 36 so that all the round collets 16 have the same height. All the pockets drilled into the holder 32 are filled with round collets 16 in this way.

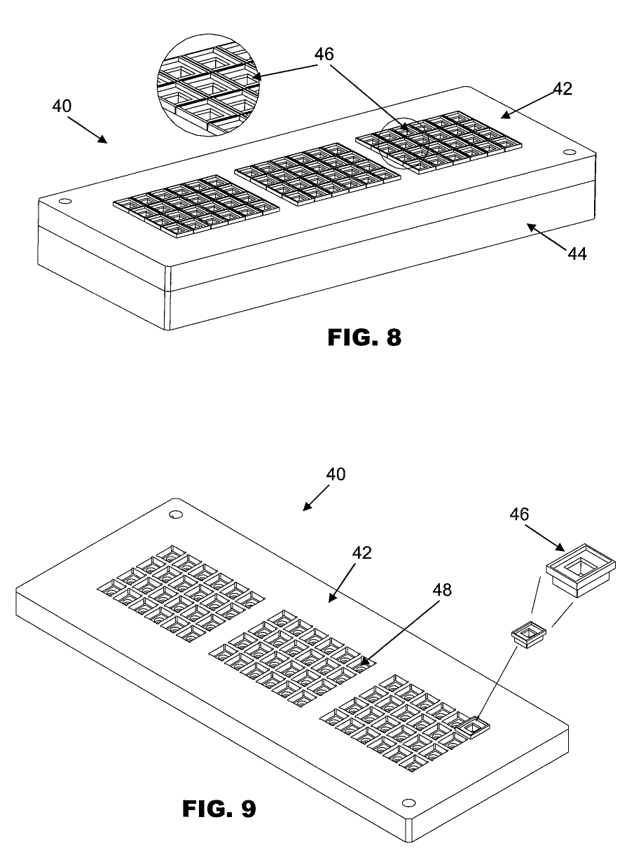

FIG. 8 is an isometric view of a saw jig 40 with individual rectangular collets 46 according to the second preferred embodiment of the invention. The saw jig has a saw jig base 42 for supporting the rectangular collets 46 and a base support 44. The rectangular collets 46 are similarly arranged in array form corresponding to the positions of electronic packages on a substrate, so that each rectangular collet 46 supports one electronic package.

These individualized rectangular collets 46 are especially suitable for the handling of larger packages (say, larger than 9×9 mm such as Ball-Grid Array packages) before, during and/or after sawing. This is because for larger packages, the corners of the package may overhang too far from the supporting vacuum region of the collet if round collets 16 are used, which affects the firmness of the support.

FIG. 9 is an isometric view of the saw jig 40 of FIG. 8 with the individual rectangular collets 46 removed to show the pockets 48 drilled into the saw jig base 42 to support the rectangular collets 46. The pockets 48 are formed according to the shape of the rectangular collets 46.

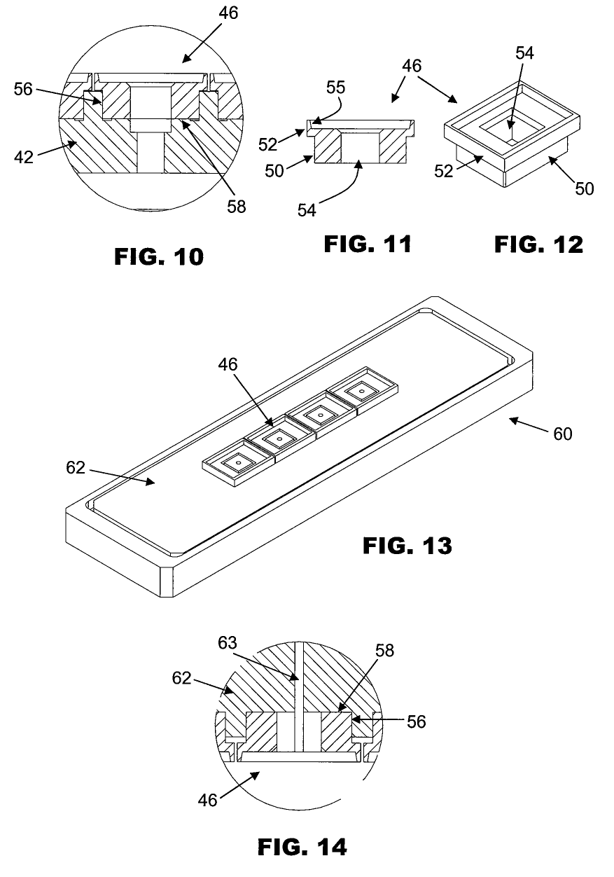

FIG. 10 is a cross-sectional view of a rectangular collet 46 that is inserted into a pocket 48 of the saw jig base 42. Each pocket 48 has guide walls 56 conforming to the shape of the rectangular collet 46 to facilitate accurate insertion of the rectangular collet 46. A reference surface 58 associated with the jig saw base 42 ensures that all the rectangular collets 46 are supported at the same height. In this case, due to the relatively larger surface area of the bottom surface of the rectangular collet 46, it is preferable for the reference surface 58 to be located on a recessed surface inside the pocket 48 that supports a surface of an inserted part of the rectangular collet 46, such as that corresponding to the bottom surface of the rectangular collet 46. The reference surface 58 is thus machined as an inner surface inside the pocket 48, instead of a top surface of the saw jig base 42.

FIG. 11 is a cross-sectional view of an individual rectangular collet 46. FIG. 12 is an isometric view of the rectangular collet 46 of FIG. 11. The rectangular collet 46 generally comprises a rectangular stem 50, a rectangular head 52 and a vacuum hole 54 passing centrally through the rectangular collet 46. To maximize the vacuum suction area, a downset recessed portion 55 is formed at the suction surface of the rectangular head 52 that is constructed with a slightly smaller width than the head 52, and adjoins the vacuum hole 54. The recessed portion 55 may further include a chamfer at its top.

The basic working principle is the same as that of the first preferred embodiment, except that the pocket 48 in the saw jig base 42 for inserting the rectangular collet 46 is rectangular in shape for ease of guiding the orientation of the rectangular collet 46 during insertion. Thus, the rectangular collet 46 is guided by four outer walls of the pocket 48 when being plugged into the saw jig base 42.

As shown in FIG. 9 and FIG. 10, the pockets 48 in the saw jig base 42 comprise an array of rectangular down-sets in order to hold the rectangular collets 46 firmly to maximize the suction area for the rectangular collets 46, and through holes to convey vacuum. The bottom surfaces of the rectangular down-set of the jig base support the rectangular collet 46 as they provide a larger area to support the rectangular collet 46 and package when the package size becomes larger.

FIG. 13 is an isometric view of a vacuum pick head 60 with individual rectangular collets 46 as shown in FIG. 12 that are arranged in a row on the pick head 60. The rectangular collets 46 are similarly supported on a holder 62 of the vacuum pick head 60. Again, this embodiment demonstrates the versatility of the rectangular collet 46 wherein the same collet design can be used to support an electronic package both in a saw jig 42 as well as in a vacuum pick head 60. Other similar uses of the rectangular collet 46 to support electronic devices may be possible.

FIG. 14 is a cross-sectional view of a rectangular collet 46 that is inserted into a pocket of the vacuum pick head 60. This is similar to the use of the round collets 16 for vacuum pick head applications. The rectangular collet 46 is inserted into the pocket guided by guide walls 56 of the pocket until it is in contact with the reference surface 58. The vacuum hole 54 of the rectangular collet 46 receives a vacuum suction force from a vacuum channel 63 in the holder 62 of the vacuum pick head 60 which is connected to a vacuum source (not shown).

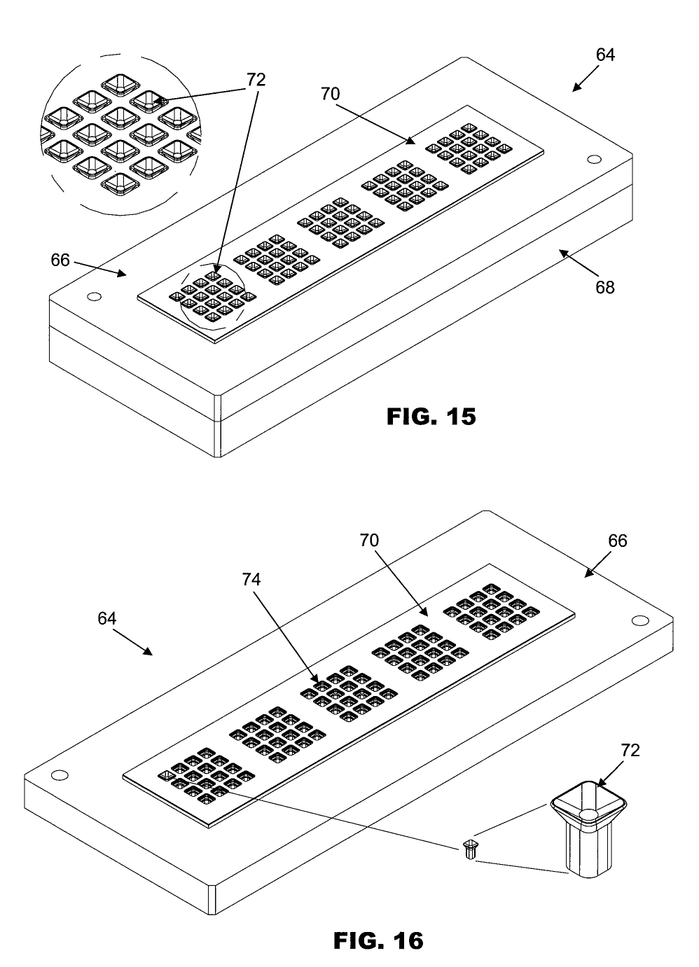

FIG. 15 is an isometric view of a saw jig 64 having a resilient platform, such as a thin rubber sheet 70 over its surface and individual rectangular collets 72 according to the third preferred embodiment of the invention. The saw jig 64 comprises a saw jig base 66 and a base support 68 holding the saw jig base 66. The thin rubber sheet 70 is laid over the saw jig base 66 to provide a resilient surface for supporting a substrate to be cut. The rectangular collets 72 are arranged in array form over the top surface of the thin rubber sheet 70 with their positions corresponding to the positions of electronic packages on a substrate, such that each rectangular collet 72 supports one electronic package.

FIG. 16 is an isometric view of the saw jig base 66 having the thin rubber sheet 70 over its surface with the individual rectangular collets 72 removed to show the pockets 74 drilled into the rubber sheet 70 and saw jig base 66 to support the rectangular collets 72. The rubber sheet preferably surrounds the locations of the pockets 74. Alternatively, the holes in the rubber sheet 70 may be formed separately from the pockets in the saw jig base 66, but that is less preferred as it may involve additional concerns as to the accuracy of the holes machined into each respective part.

The basic working principle of the third preferred embodiment of the invention and its corresponding advantages are similar to that of the first preferred embodiment. However, the third preferred embodiment has some differences in terms of its working method and provides additional advantages in handling Quad-Flat No-Lead (“QFN”) packages with harder metal leads to be sawn through.

The thin rubber sheet 70 is adhered (such as by adhesive) onto the top of the saw jig base 66 that is preferably made from metal, say aluminum. The rubber sheet 70 is preferably made from a rigid material for firmer support, and preferably has higher friction factor. The small thickness of the rubber sheet helps to further enhance the overall rigidity of the “rubber plus metal” structure. The rubber sheet 70 is preferably about 0.1 mm to 1 mm thick.

The saw jig base 66 consists of array of pockets 74 that match the package array distribution of the substrate to be sawn. Each pocket 74 has a larger rectangular down-set at an upper part that supports and holds an electronic package by vacuum suction created in the rectangular collet 72, and a smaller rectangular down set at a lower part where the rectangular collet 72 is plugged into firmly and rests onto the down-set base of the pocket 74. A through hole in the saw jig base 66 is connected to the pocket 74 to transmit vacuum to the rectangular collet 72.

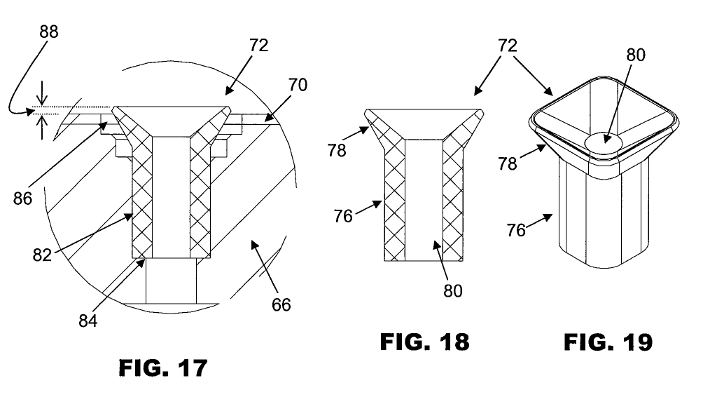

FIG. 17 is a cross-sectional view of a rectangular collet 72 that is inserted into a pocket 74 of the saw jig base 66 according to the third preferred embodiment of the invention. Each pocket 74 has guide walls 82 conforming to the shape of the rectangular collet 72 to facilitate insertion of the rectangular collet 72 into the pocket 74. A reference surface 84 associated with the pocket 74 ensures that each rectangular collet 72 is supported at the same height.

In this preferred embodiment, each pocket 74 further comprises a chamfer 86 at the opening of the pocket 74. This is because an upper surface of the rectangular collet 72 protrudes for a small distance 88 above a top surface of the rubber sheet 70, and when an electronic package is supported on a sealing lip of the rectangular collet 72, the chamfer 86 is sized so as to allow the sealing lip to bend freely while supporting the electronic package, without touching the saw jig base 66 or the rubber sheet 70. Although the resilient platform preferably comprises a single sheet of resilient material that is laid over an area of the saw jig base 66 comprising a plurality of pockets 74, it may for example comprise instead of separate pieces of resilient material surrounding each pocket 74.

FIG. 18 is a cross-sectional view of an individual rectangular collet 72 according to the third preferred embodiment. FIG. 19 is an isometric view of the rectangular collet 72 of FIG. 18. This design of the rectangular collet 72 comprises a stem 76 and a sealing lip 78. A vacuum hole 80 passes centrally through the rectangular collet 72.

The sealing lip 78 of the rectangular collet 72 is relatively thinner in cross-section as compared to the upper parts of the other collets described in the other embodiments and it is made more flexible. The sealing lip 78 protrudes slightly (for instance, 0.2 to 0.5 mm) from the top surface of the rubber sheet 70. The sealing lip 78 is of a rectangular shape and has small fillets at its corners, such that it can deform easily when vacuum is built up inside the pad. The electronic package is then sucked firmly and this creates a vertical pulling force to allow the package to sit firmly onto the rubber sheet around the upper pocket of the saw jig base 66.

The lower part of the rectangular collet 72 is a straight stem 76 that has a rectangular shape with small fillets at the corners and a round vacuum hole 80 at its center. Its outside rectangular shape has interference fit with the pocket walls 82 of the saw jig base 66 while resting on the reference surface 84 on the down set base in the pockets of the saw jig base 66. With the rectangular shape of the stem 76, the pad cannot rotate freely and can also be aligned easily with the required orientation that matches with the package orientation to provide geometric support.

With such a saw jig design, the substrate can be handled in the following way before and during sawing. The substrate placed on the saw jig 64 is flattened by a press plate as usual. Vacuum is activated under the saw jig 64 and is conveyed to the sealing lip 78 of each rectangular collet 72. As the sealing lips 78 of the rectangular collets 72 protrude only slightly (say, for 0.2 to 0.5 mm) and are so soft that they deform according to the shape of the bottom (usually molded) surface of the substrate, a good sealing is achieved with a lighter force exerted from the press plate. As a result, high vacuum can built up and maintained on all the packages of the substrate even after the press plate is removed for sawing, and the substrate is flatly resting on the saw jig surface. A much better capability to handle substrate warpage is therefore one of the advantages of this third preferred embodiment.

During sawing, in addition to a vertical holding force securing the package that is created by vacuum suction, a sufficient horizontal holding force is also required. It can be provided from the rubber surface of the rubber sheet 70 laid on the saw jig base 66 which offers a high-friction surface. The hard and thin rubber sheet 70 can provide a more rigid foundation than that provided solely by a plastic collet that has to be soft in order to promote vacuum build-up (as shown in the first embodiment). A rigid foundation supporting the package is important in avoiding vibration of the substrate and electronic packages during sawing, or bad sawing quality on the side leads and mold chipping will result. It is especially useful and important for QFN packages that comprise metal leads and plastic molding.

The said rectangular shape of the rectangular collets 72 is good for middle to large sized QFN packages (say from 5×5 mm or above) as it can maximize the suction area. For smaller QFN packages of, say 3×3 mm or smaller, round shaped collets and corresponding round pockets on saw jigs are preferred because of the relatively small surface area and negligible loss in suction area, while at the same time, easier machining of the pockets of the saw jig base is possible.

The first and second preferred embodiments of the invention have the advantage of reduced cost because the collets are standard components that can be used in various handling applications, and thus they can be made from relatively cheaper mass-production methods such as molding. At the same time, the pockets for holding the collets, whether they are located on the saw jig base, pick head base or other tools are comparatively easier to machine. Similarly, one can keep stocks of the standard mass-produced collets that are not high in cost, to achieve faster lead time.

There is also ease of maintenance since one only needs to replace the vacuum collets that are damaged with the mass-produced ones that have been stocked. There is no need to replace the whole jig or panel when just some of the collets are damaged. Further, there is a better capability to handle substrate warpage due to the softness of the collets. The collets can be maintained at the precise positions as machined on the pockets of the metallic jig base over time. In contrast, for those saw jigs or pick heads made from whole pieces of composite rubber sheets with metal bases, the positions of the pockets can change due to aging over time.

The third preferred embodiment of the invention has additional advantages in that there is even better warpage handling of the substrate due to the soft sealing lips of the vacuum collets. A better horizontal holding force and a stronger foundation are also provided for the packages as a thin and hard rubber sheet adhering to the saw jig base is provided to support the packages. Moreover, the suction area is maximized. As a result, high friction and rigid support provided by the rubber sheet result in better sawing quality.

The invention described herein is susceptible to variations, modifications and/or additions other than those specifically described and it is to be understood that the invention includes all such variations, modifications and/or additions which fall within the spirit and scope of the above description.

1. A saw jig for mounting a substrate containing a plurality of electronic devices, comprising:
a base platform having a plurality of pockets laid out in the same arrangement as the electronic devices are arranged on the substrate; and
a plurality of resilient collets that are detachably inserted into the pockets, each collet being sized and configured to hold one electronic device by vacuum suction.

2. The saw jig as claimed in claim 1, wherein each pocket is constructed to form an interference fit with the collet after the collet is inserted into the pocket.

3. The saw jig as claimed in claim 1, further comprising guide walls in each pocket that conform to a shape of the collet for insertion, and a planar reference surface on which the collet rests when inserted so that all the collets are mounted at the same height.

4. The saw jig as claimed in claim 3, wherein the reference surface is located on a flat top surface of the base platform.

5. The saw jig as claimed in claim 3, wherein the reference surface is located on a recessed surface inside the pocket that supports a surface of an inserted part of the collet.

6. The saw jig as claimed in claim 1, wherein the collet comprises a cylindrical head and a cylindrical stem, the head being configured to be exposed above the base platform after insertion of the stem into the pocket.

7. The saw jig as claimed in claim 6, wherein the cylindrical stem has a smaller diameter than the cylindrical head.

8. The saw jig as claimed in claim 7, further comprising a substantially flat shoulder between the head and the stem, which together with a top surface of the base platform forms a planar reference surface to ensure that the collets all are mounted at substantially the same height.

9. The saw jig as claimed in claim 6, including a vacuum hole centrally located in the collet and a chamfer located at a suction surface of the head adjoining the vacuum hole to provide a larger vacuum suction area.

10. The saw jig as claimed in claim 1, wherein the collet comprises a rectangular head and a rectangular stem.

11. The saw jig as claimed in claim 10, including a downset recess portion formed at a suction surface of the head that is constructed with a slightly smaller width than the head, and a vacuum hole adjoining the downset recess portion.

12. The saw jig as claimed in claim 1, including a resilient platform adhered over a top surface of the base platform surrounding the locations of the pockets.

13. The saw jig as claimed in claim 12, wherein the resilient platform is made with a rigid material with a high friction factor.

14. The saw jig as claimed in claim 12, wherein the resilient platform has a thickness of between 0.1 mm and 1 mm.

15. The saw jig as claimed in claim 12, wherein the collet has a deformable sealing lip that protrudes for a certain distance from a top surface of the resilient platform.

16. The saw jig as claimed in claim 15, further comprising a downset at an opening of the pocket that is sized such that bending of the deformable sealing lip does not result in contact between the sealing lip and the resilient platform or base platform.

17. The saw jig as claimed in claim 12, the resilient platform comprises a single resilient sheet of material laid over an area of the base platform comprising a plurality of pockets.

18. The saw jig as claimed in claim 1, wherein the collets are also configured to be inserted into a pick head having one or more pockets constructed for interference fitting of the collet.

19. The saw jig as claimed in claim 1, wherein the base platform is made from metal and the pockets are machined into the base platform.

20. The saw jig as claimed in claim 1, wherein the collets are made by molding with rubber or elastomer.
